(19) United States
(12) Patent Application Publication
(10) Pub. No.: US 2007/0140462 A1
(43) Pub. Date: Jun. 21, 2007

(54) TELEPHONE EXCHANGE APPARATUS AND CONTROL METHOD FOR GROUP INCOMING OF THE SAME

(76) Inventor: Seiichi Yamamoto, Sagamihara-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/470,214

(22) Filed: Sep. 5, 2006

(30) Foreign Application Priority Data
Dec. 15, 2005 (JP) 2005-361957

(51) Int. Cl. H04M 7/00

(52) U.S. Cl. 379/219

(57) ABSTRACT

According to one embodiment, a telephone exchange apparatus includes a memory which stores a second management table associating a terminal ID specifying a first telephone terminal among the plurality of telephone terminals with a terminal ID specifying a second telephone terminal belonging to the group, when an incoming call addressed to a group is reached from the first telephone terminal and a response to the incoming call is made by the second telephone terminal, and a controller which refers the second management table based on the terminal ID of the first telephone terminal included in an incoming call addressed from the first telephone terminal to a group to which the second telephone terminal belonged thereto, when the incoming call is received, and performs incoming control with top priority to the second telephone terminal based on the reference result.

### CROSS-REFERENCE TO RELATED APPLICATIONS

This application is based upon and claims the benefit of priority from the prior Japanese Patent Application No. 2005-361957, filed Dec. 15, 2005, the entire contents of which are incorporated herein by reference.

### BACKGROUND OF THE INVENTION

1. Field of the Invention

One embodiment of the invention is related to a telephone exchange apparatus and a control method for group incoming of the exchange apparatus which is equipped with, for instance, a multi-appearance function, an extension representative group incoming function, and a multiple calling function, etc.

2. Description of the Related Art

In general, the telephone exchange apparatus has a variety of service functions and one of them is the multi-appearance function. In the multi-appearance function, a plurality of extension terminals constitute one multi-appearance group and equivalently distribute incoming calls addressed to the multi-appearance group into the extension terminals therein. Usually, one representative number is added to the multi-appearance group, and a caller can reach a call at an extension terminal in the multi-appearance group by dialing the representative number.

By the way, the plurality of extension terminals ring simultaneously in response to the dialed representative number and any one makes a response actually as the case may be, in the multi-appearance function. In such a case, if someone makes a call to the representative number once and dials the representative number again before completing business after talking about the business, it is a possible case that a person other than the previous person makes a response to the second dialing. Then, this case troubles the caller to talk about the business again, or troubles the person who has received the incoming to ask the caller that with whom the caller expect to talk, and then has to change place with the expected person or transfer the incoming call to the desired extension terminal.

Conventionally, a technique exists, in which after a user of an extension terminal performs a call originating processing to an ISDN network, the user stores a caller number and an incoming destination number by associating them with an incoming destination specifying memory, and then the user refers to the content stored in the memory to make only the corresponding extension terminal receive the incoming call when the user receives an incoming call from a telephone terminal on the ISDN network.

In the above-described technique, however, in the case where the user of the extension terminal has made a telephone call to the ISDN network, even if the user disconnects the telephone call, the user of the same extension terminal makes a response. So that it is impossible for the technique to be applied to the case in which the caller dial operation is addressed to the multi-appearance group.

### BRIEF DESCRIPTION OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of an exchange system regarding a first embodiment of the present invention;

FIG. 2 is an exemplary view showing an example of a stored content in a multi-appearance management table shown in FIG. 1;

FIG. 3 is an exemplary view showing an example of a stored content in a responder management table shown in FIG. 1;

FIG. 4 is an exemplary flowchart showing a processing procedure of a central control unit in performing registration in the responder management table in the first embodiment;

FIG. 5 is an exemplary flowchart showing a processing procedure of the central control unit after performing the registration in the responder management table in the first embodiment; and

FIG. 6 is an exemplary flowchart showing a processing procedure of a central control unit in performing registration in a responder management table regarding a second embodiment of the present invention.

### DETAILED DESCRIPTION OF THE PREFERRED EMBODIMENT

Various embodiments according to the invention will be described hereinafter with reference to the accompanying drawings, In general, according to one embodiment of the invention, a telephone exchange apparatus, executing exchange processing among a plurality of telephone terminals, including a first management table associating a plurality of groups constituted by dividing a plurality of telephone terminals with telephone terminals belonging to the groups, and performing incoming control for a plurality of telephone terminals of the corresponding group by referring to the first management table, when an incoming call addressed to the group is reached, the apparatus comprising: a memory which stores a second management table associating a terminal ID specifying a first telephone terminal among the plurality of telephone terminals with a terminal ID specifying a second telephone terminal belonging to the group, when an incoming call addressed to a group is reached from the first telephone terminal and a response to the incoming call is made by the second telephone terminal; and a controller which refers the second management table based on the terminal ID of the first telephone terminal included in an incoming call addressed from the first telephone terminal to a group to which the second telephone terminal belonged thereto, when the incoming call is received, and performs incoming control with top priority to the second telephone terminal based on the reference result.

### First Embodiment

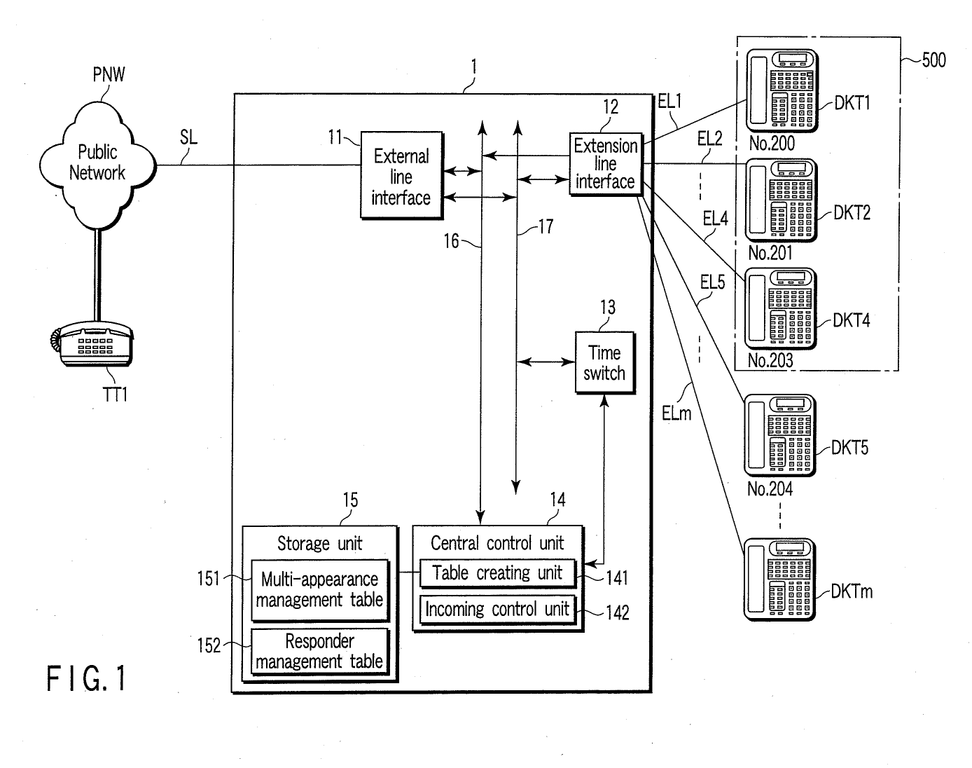

FIG. 1 is the bock diagram showing the exchange system regarding the first embodiment and a main apparatus 1 as the telephone exchange apparatus is shown therein.

The main apparatus 1 includes an external line interface unit 11, an extension line interface unit 12, a time switch 13, a central control unit 14 and a storage unit 15. Out of them, the external line interface unit 11, the extension line interface unit 12 and the central control unit 14 are connected with one another via a control bus 16. The external line interface unit 11, the extension line interface unit 12 and the time switch 13 are connected via a voice bus 17 with one another.

The external interface unit 11 is connected to a public network PNW via a subscriber line SL to perform establishment processing of a call to and from the public network PNW, etc.

The extension interface unit 12 houses a plurality of extension lines EL1-ELm (m is natural number) and the extension lines EL1-ELm connect to extension terminals DKT1-DKTm, respectively. As for the extension terminals DKT1-DKTm, for instance, digital key telephone sets are each used. The extension line interface unit 12 each performs call originating/call incoming processing and transfer processing of digital signals, etc., to the extension terminals DKT1-DKTm.

The time switch 13 conducts channel exchange of the digital signals transmitted between the external line interface unit 11 and the extension line interface unit 12 via the voice bus 17 in accordance with an instruction form the central control unit 14.

The central control unit 14 executes call originating processing which accompanies calling requests of each extension terminal DKT1-DKTm, usual incoming processing accompanying external line incoming from the subscriber line SL, and transfer processing among the extension terminals DKT1-DKTm, etc.

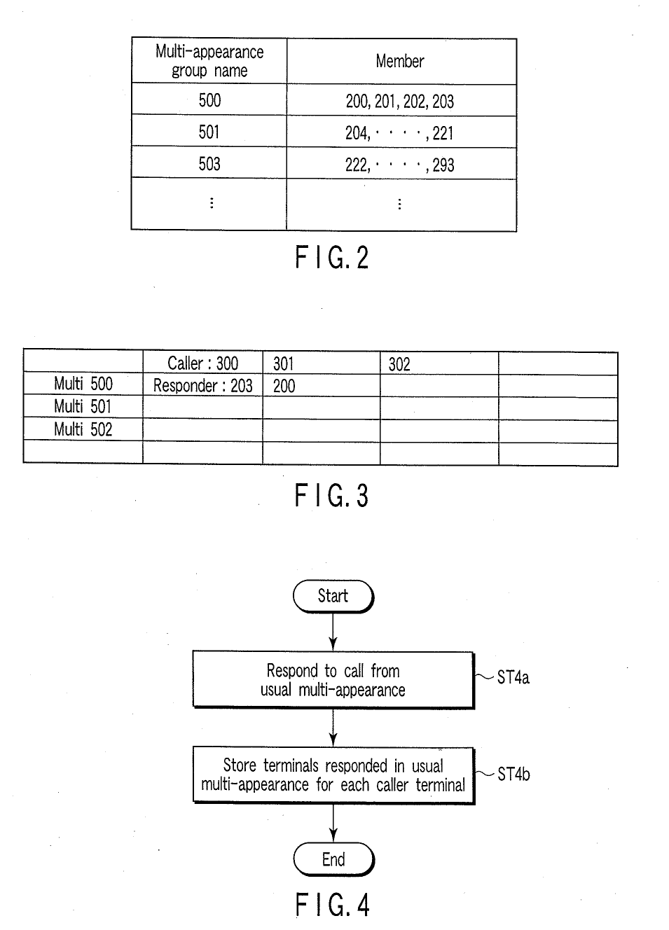

The storage unit 15 stores control data necessary for the control processing by the central control unit 14. The storage unit 15 includes a multi-appearance management table 151. The management table 151 stores, as shown in FIG. 2, data indicating correspondence relationships between a plurality of multi-appearance groups composed by dividing the extension terminals DKT1-DKTm and the extension terminals belonging to the multi-appearance group.

Now, in the first embodiment, the central control unit 14 includes a table creating unit 141 and an incoming control unit 142. The table creating unit 141, for instance, when an incoming call addressed to a multi-appearance group (500) is reached from an extension terminal DKT9 (300) and a response is made for the incoming call by the extension terminal DKT4 (203) belonging to the multi-appearance group (500), stores, as shown in FIG. 3, the extension number (300) as the terminal ID of the extension terminal DKT9 and the extension number (203) of the extension terminal DKT4 by associating with each other in a responder management table 152 of the storage unit 15.

The incoming control unit 142 refers to the responder management table 152 based on the extension number (300) of the extension terminal DKT9 included in an incoming call when the incoming call addressed to the multi-appearance group (500) is reached from the extension terminal DKT9 (300) again to specify the extension number (203) of the extension terminal DKT4 based on the reference result, and also executes incoming control to the extension terminal DKT4 with the highest priority.

Operations of the system configured as described above will be explained as follows.

FIG. 4 is a flowchart showing the processing procedure of the central control unit 14 in performing registration in the responder management table 152.

For example, it is presumed that a user of the external telephone terminal TT1 performs a dial operation of ‘500’ so as to make a call with a user of the multi-appearance group (500). Then, the external telephone terminal TT1 sends its incoming call to the main apparatus 1 via the public network PNW. When receiving this incoming call, the main apparatus 1 determines the extension terminals DKT1-DKTm so as to receive the incoming call based on the management table 151 and also determines whether or not the telephone number of the external telephone terminal TT1 has been registered in the management table 152. If the telephone number of the external telephone terminal TT1 is not included in the incoming call, the main apparatus 1 determines only the extension terminals DKT1-DKTm so as to receive the incoming call.

Here, the telephone number of the external telephone terminal TT1 has not been registered in the responder management table 152, so that the central control unit 14 of the mater device 1 reads out all extension terminals DKT1-DKT4 belonging to the multi-appearance group (500) from the multi-appearance management table 151 and transfers each incoming data to the extension terminals DKT1-DKT4, respectively, to make them conduct incoming notifications (block ST4a).

If the user of the extension terminal DKT4 made a response, the central control unit 14 associates the extension terminal DKT4, which has made the response, with the telephone number of the external telephone terminal TT1 to store it in the responder management table 152 (block ST4b).

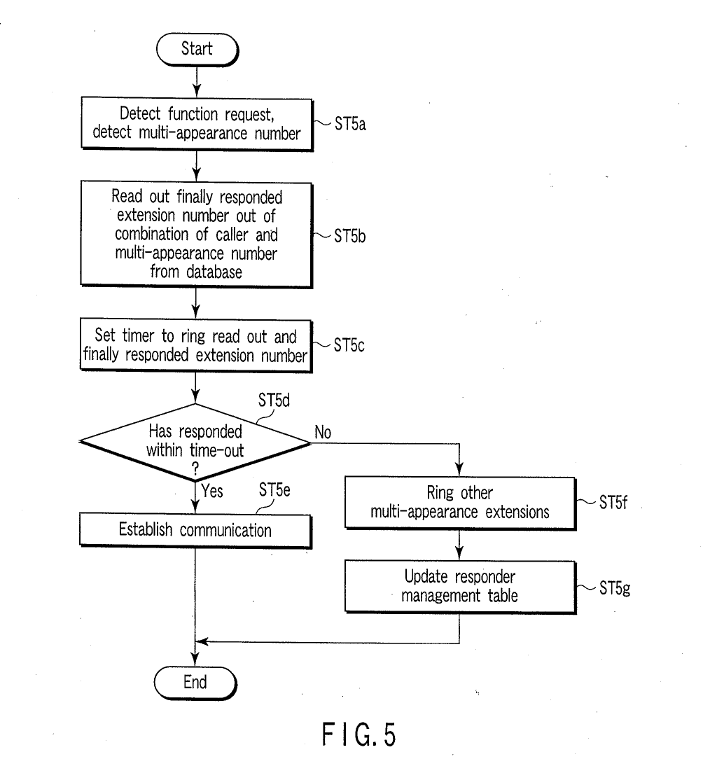

FIG. 5 is a flowchart showing the processing procedure of the central control unit 14 after performing the registration in the responder management table 152.

It is supposed that the user of the external telephone terminal TT1 conducts the dial operation of ‘500’ again so as to make the call to the user belonging to the multi-appearance group (500). The external telephone terminal TT1 then sends the incoming call to the main apparatus 1 via the public network PNW. When receiving the incoming call, the main apparatus 1 determines the extension terminal DKT1-DKTm in order to receive the incoming call based on the multi-appearance management table 151 and also determines whether or not the telephone terminal of the external telephone terminal TT1 has been registered in the responder management table 152 (block ST5a).

Because the telephone number of the external telephone terminal TT1 has been registered in the responder management table 152, the central control unit 14 of the main apparatus 1 reads out the extension terminal DKT4 from the responder management table 152 (block ST5b) and transfers the incoming data to the extension terminal DKT4 to make it conduct an incoming notification (block ST5c). And simultaneously, the central control unit 14 starts up a timer (not shown).

In succession to this, the central control unit 14 monitors whether or not the user of the extension terminal DKT4 responds within a time-out (block ST5d), if the user of the extension terminal DKT4 has made a response (Yes, in block ST5d), the central control unit 14 establishes a communication link between the extension terminal DKT4 and the external telephone terminal TT1 (block ST5e).

Thus, the user of the external telephone terminal TT1, even if it disconnects the telephone call, can talk about business to the user of the extension terminal DKT4 successively.

In contrast, if the user of the extension terminal DKT4 has not made the response after the time-out, the central control unit 14 reads out the extension terminals DKT1-DKT3 other than the extension terminal DKT4 from the multi-appearance management table 151 and transfers each incoming data to the extension terminals DKT1-DKT3 to make them conduct incoming notifications, respectively (block ST5f).

If the user of the extension terminal DKT3 has made a response, the central control unit 14 updates the stored contents in the responder management table 152 so as to associate the extension number of responded extension terminal DKT3 with the telephone number of the external telephone terminal TT1 (block ST5g).

As mentioned above, in the first embodiment, when the incoming call addressed to the multi-appearance group (500) is reached from the external telephone terminal TT1, and if the extension terminal DKT4 belonging to the multi-appearance group (500) has made a response to the incoming call, the central control unit 14 of the main apparatus 1 stores the telephone number of the external telephone terminal TT1 and the extension number of the extension terminal DKT4 in the responder management table 152 by associating them with each other. And when receiving the incoming call addressed to the multi-appearance group (500) from the external telephone terminal TT1 again, the central control unit 14 specifies the extension number of the extension terminal DKT4 by referring to the responder management table 152 based on the telephone number of the external telephone terminal TT1 to make the extension terminal DKT4 ring first.

Accordingly, even if the user of the external telephone terminal TT1 disconnects once and conducts the dial operation for the same multi-appearance group again, after the user of the external telephone terminal TT1 makes a telephone call with the user of the extension terminal DKT4 belonging to the multi-appearance group (500), the user of the external telephone terminal TT1 can make a telephone call with the user of the extension terminal DKT4 successively. Thereby, for the user of the external telephone terminal TT1, troublesome of talking about the business again and the like can be reduced.

And in the first embodiment, if the user of the extension terminal DKT4 has not made a response within a prescribed time interval but the user of the extension terminal DKT3 belonging to the same multi-appearance group (500) has made a response, the extension number of the extension terminal DKT4 corresponding to the telephone number of the external telephone terminal TT1 stored in the responder management table 152 is automatically updated into the extension number of the extension terminal DKT3, so that registration operations can be extremely reduced.

In the forgoing first embodiment, since the registration of the responder management table 152 is executed in groups or in callers, even when incoming calls addressed to a plurality of groups regarding different callers are made in the same time band, the exchange system can process these incoming calls in parallel at every group or caller.

### Second Embodiment

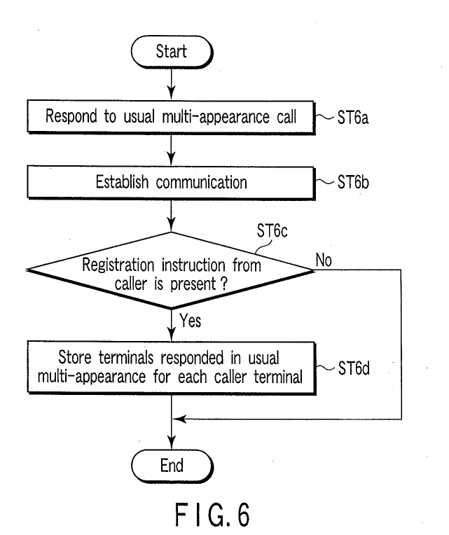

FIG. 6 is a flowchart showing the processing procedure of the central control unit 14 in performing registration in the responder management table 152. Here, to conduct the registration in the responder management table 152, telephone numbers are not automatically stored therein, but they are stored with an input of a registration instruction from the caller after establishment of the telephone call or an input of a function key as a trigger.

For instance, it is presumed that the user of the extension terminal DKT8 conducts a dial operation of ‘500’ in order to make a telephone call with the user of the multi-appearance group (500). The extension terminal DKT8 sends its incoming call to the main apparatus 1. When receiving this incoming call, the main apparatus 1 determines the extension terminals DKT1-DKTm so as to receive the incoming call based on the multi-appearance management table 151 and also determines whether or not the extension number (301) of the extension terminal DKT8 has been registered in the responder management table 152.

Because the extension number of the extension terminal DKT8 has not registered in the responder management table 152, the central control unit 14 of the main apparatus 1 reads out all extension terminals DKT1-DKT4 belonging to the multi-appearance group (500) from the multi-appearance management table 151 and transfers each incoming data to the extension terminals DKT1-DKT4 to make them perform incoming notifications, respectively (block ST6a).

Here, if the user of the extension terminal DKT1 has made a response, the central control unit 14 forms a communication link between the extension terminal DKT1 and the extension terminal DKT8 (block ST6b).

In this state, it is assumed that the user of the extension terminal DKT8 has input a registration instruction to the responder management table 152 in the extension terminal DKT8. The central control unit 14 then makes a shift from the block ST6c to the block ST6d and stores the extension number of the extension terminal DKT1 and the extension terminal DKT8 by associating them with each other, in the block ST6d.

Further, in the block ST6c, if the user of the extension terminal DKT8 disconnects the telephone call without inputting the registration instruction to the responder management table 152, the central control unit 14 terminates the processing in this flowchart.

As described above, in the second embodiment, the user itself of the extension terminal DKT8 can determine whether or not the exchange system has to perform the registration in the responder management table 152, thereby the user can register in the responder management table 152 only when the need arises really.

### Other Embodiments

The present invention is not limited to each embodiment described above. For instance, in the first and second embodiments, they have been described in accordance with the multi-appearance functions as examples. However, the present invention is not limited to these embodiments, even for an extension representative incoming function to switch terminals to be called one by one in rotation and a multiple calling function to increase incoming members by several sets, the exchange system similarly selects the terminal to firstly receive the incoming call.

Other than this, even for types of the telephone exchange apparatus (not limited to main device but a PBX is available) and configurations, for types of the extension terminals, for registration procedures to the responder management table, and for incoming control procedures using the responder management table, a variety of modifications can be made without departing from the sprit or concept of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone exchange apparatus, executing exchange processing among a plurality of telephone terminals, the telephone exchange apparatus comprising:
a first management table associating a plurality of telephone terminals into at least one group;
a second management table that is configured to associate a terminal ID specifying a first telephone terminal with a terminal ID specifying a second telephone terminal, when a first incoming call addressed to the group from the first telephone terminal is answered by the second telephone terminal; and
a controller which is configured to obtain the terminal ID of the second telephone terminal from the second management table based on the terminal ID of the first telephone terminal when a second incoming call is addressed from the first telephone terminal to the group, and wherein the controller directs the second incoming call to the second telephone terminal based on the second terminal ID.

2. The telephone exchange apparatus according to claim 1, wherein the controller is further configured to associate the terminal ID of the first telephone terminal in the second management table with a terminal ID of a third telephone terminal belonging to the group when the second telephone terminal has not responded within a time interval and the third telephone terminal has responded.

3. The telephone exchange apparatus according to claim 1, wherein the second management table associates the terminal ID of the first telephone terminal with the terminal ID of the second telephone terminal in response to an operation of a key provided at the first telephone terminal, when a communication connection has been established between the first telephone terminal and the second telephone terminal.

4. The telephone exchange apparatus according to claim 1, wherein the second management table associates the terminal ID of the first telephone terminal with the terminal ID of the second telephone terminal for each of at least one of the group and a caller.

5. The telephone exchange apparatus according to claim 1, wherein the terminal ID of the second telephone terminal is the extension of the second telephone terminal.

6. The telephone exchange apparatus according to claim 1, wherein the second management table further stores a group identifier.

7. The telephone exchange apparatus according to claim 1, wherein the second management table is stored in a memory.

8. A method of processing calls, the method comprising:
creating a management table that associates a terminal ID specifying a first telephone terminal with a terminal ID specifying a second telephone terminal, when an incoming call addressed to a group associated with a plurality of the second telephone terminals from the first telephone terminal is answered by the second telephone terminal;
obtaining the terminal ID of the second telephone terminal from the management table based on the terminal ID of the first telephone terminal when a second incoming call is addressed from the first telephone terminal to the group; and
directing the second incoming call to the second telephone terminal based on the second terminal ID.

9. The method according to claim 8, further comprising updating the terminal ID of the second telephone terminal corresponding to the terminal ID of the first telephone terminal in the management table with a terminal ID of a third telephone terminal belonging to the group, when the second telephone terminal has not responded within a time interval and the third telephone terminal has responded.

10. The method according to claim 8, further comprising associating in the management table, the terminal ID of the first telephone terminal with the terminal ID of the second telephone terminal in response to an operation of a key provided for the first telephone terminal, when a communication connection has been established between the first telephone terminal and the second telephone terminal.

11. The method according to claim 8, associating in the management table, the terminal ID of the first telephone terminal with the terminal ID of the second telephone terminal for each at least one of the group and a caller.

12. The method according to claim 8, wherein the terminal ID of the second telephone terminal is the extension of the second telephone terminal.

13. The method according to claim 8, wherein the management table further stores a group identifier.

14. The method according to claim 8, wherein the management table is stored in a memory.

15. A telephone exchange apparatus comprising:
a management table that is configured to associate a terminal ID specifying a first telephone terminal with a terminal ID specifying a second telephone terminal wherein the second telephone terminal is associated with a group of telephone terminals and wherein an incoming call from the first telephone terminal is answered by the second telephone terminal; and
a controller which is configured to obtain the terminal ID of the second telephone terminal from the management table based on the terminal ID of the first telephone terminal when a second incoming call is addressed from the first telephone terminal to the group, and wherein the controller directs the second incoming call to the second telephone terminal based on the second terminal ID.

16. The telephone exchange apparatus according to claim 15, wherein the controller is further configured to associate a terminal ID of a third telephone terminal belonging to the group with the terminal ID of the first telephone terminal when the second telephone terminal has not responded within a time interval and the third telephone terminal has responded.

17. The telephone exchange apparatus according to claim 15, wherein the management table associates the terminal ID of the first telephone terminal with the terminal ID of the second telephone terminal in response to an operation at the first telephone terminal.

18. The telephone exchange apparatus according to claim 15, wherein the second management table associates the terminal ID of the first telephone terminal with the terminal ID of the second telephone terminal for each at least one of the group and a caller.

19. The telephone exchange apparatus according to claim 15, wherein the terminal ID of the second telephone terminal is the extension of the second telephone terminal.

20. The telephone exchange apparatus according to claim 15, wherein the management table further stores a group identifier.
